(19) United States
(12) Patent Application Publication
(10) Pub. No.: US 2010/0185486 A1
(43) Pub. Date: Jul. 22, 2010

(54) DETERMINING DEMAND ASSOCIATED WITH ORIGIN-DESTINATION PAIRS FOR BUS RIDERSHIP FORECASTING

(75) Inventors: MELANIE R. BARKER, ORLANDO, FL (US); KURT KAUFMANN, ORLANDO, FL (US); JOSE MOLA, ORLANDO, FL (US); G. NEIL SIMMONS, MT. DORA, FL (US); PETER S. BUCZKOWSKI, WINDERMERE, FL (US); DOUGLAS C. LORD, WINTER GARDEN, FL (US); LARRY B. ROOS, ORLANDO, FL (US); FRANK J. TORTORICI, Jr., GOTHA, FL (US); KATHLEEN A. KILMER, WINTER GARDEN, FL (US)

Correspondence Address: DISNEY ENTERPRISES, INC.;c/o Marsh Fischmann & Breyfogle LLP, 8055 East Tufts Avenue, Suite 450, Denver, CO, 80237, US

(73) Assignee: DISNEY ENTERPRISES, INC., BURBANK, CA (US)

(21) Appl. No.: 12/356,669

(22) Filed: Jan. 21, 2009

(51) Int. Cl. G06Q 10/00; G06Q 50/00

(52) U.S. Cl. 705/10

(57) ABSTRACT

A method for forecasting demand for transportation services. The method includes running a count-to-demand translation module with a processor on a computer system and, with the computer system, receiving a count data for passengers getting on and off a vehicle at each stop along a route. The method includes operating the translation module to determine a demand for pairs of the stops such as origin-destination pairs on the route based on the counts at each stop. The set of count data includes a geographical location associated with each stop as well as the time. The demand found by the translation module is attributed to predefined time periods. In the method, the demand of at least some of the OD pairs of the stops is proportional to the offcounts at the destination one of the stops in the pairs relative to the offcounts in the other destination stops.

### BACKGROUND OF THE INVENTION

1. Field of the Invention

The present invention relates, in general, to methods and systems for predicting the number of riders or ridership for public or private transportation such as buses or other vehicles and planning deployment or dispatching of buses/vehicles and drivers based on such ridership predictions, and, more particularly, to systems and methods using counts of riders getting on (or embarking) and off (or disembarking) a bus or other vehicle to forecast future ridership or demand and to generate labor assignments and bus/vehicle fleet dispatching schedules based on these more accurate ridership forecasts.

2. Relevant Background

In many locations, there is a growing demand for transportation, such as buses and other multi-passenger vehicles, to carry passengers or riders from numerous origins to a variety of destinations. Public transportation has long provided buses that travel along predefined routes and pick up and drop off passengers along the route. These routes typically are consistent for weekdays and have a different schedule for weekends to accommodate city demands. Private transportation systems are often used to transfer riders from one location to another such as from a parking lot, a hotel/resort, or a business to another business or destination such as a sporting arena, a ski hill, an amusement park, and so on. Airports often have shuttle vans to accommodate airline passengers staying at city-center hotels that do not rent a personal vehicle.

A common goal for transportation providers is to meet the demand for buses or vehicles. A conflicting goal, though, is to control costs including meeting demand without over-servicing a route. For example, running buses on routes at low capacity is not cost efficient, and it is desirable to run enough buses to service ridership demand while keeping ridership at a particular level. Planning bus routes, dispatching buses, and providing enough drivers can be complicated due to these and other operating considerations.

For example, it may be a goal of the transportation provider to make getting to and from an amusement park or other destination part of the overall experience or, in other words, to be hassle free and enjoyable. This may be a difficult task, though, if that transportation provider has to service numerous pick up locations or origins and also service a variety of drop off locations or destinations. One example may be an amusement park complex made up of a number of entertainment facilities (“destinations”) as well as numerous origins for park guests such as parking lots, hotels/resorts, and other entertainment facilities. Of course, the labels are often reverse with origins becoming destinations when the busses are traveling the other direction (e.g., returning guests to their vehicles or hotels). Bus operations may involve dispatching hundreds of buses in such an operation and assigning hundreds to a thousand or more drivers to drive these buses during all operating hours for the complex. In one setting, statistics have shown that over one hundred thousand riders are serviced everyday by the amusement park complex buses.

Existing transportation systems typically are reactive rather than proactive. Specifically, public transportation is typically provided along routes that are set based on polls of the local population and predictions of where needs may exist, such as to and from a business district of a city. The routes and number of buses may be periodically changed based on a reaction to complaints of the riders, based on driver input as to demand, or based on physical counts of riders on a route (e.g., count number of passengers boarding each bus). In the resort or amusement complex example, routes and need for buses/drivers is typically planned by manually estimating the resort population (i.e., number of guests staying at the resort) and expected visitors (e.g., for parking lots and exits), estimating times these guests may travel on various routes, estimating demand for various routes, and then assigning a fitting number of buses to each of these routes. In some cases, the number of buses and routes is adjusted based on driver and user feedback, but, at this point, the feedback is typically a complaint about the lack of service or an unenjoyable experience involving waiting long periods for a bus. Guest service is typically much more important in the amusement park scenario than for city transit, since guest satisfaction is directly related to the intent of the guest to return to the park.

Hence, there remains a need for improved methods and systems for better determining actual demand for bus or other transportation services. Preferably, such a method and system would provide results that would facilitate better prediction of future demands for transportation services that can be used to plan routes, frequency of buses/vehicles on routes, number of vehicles for a particular day, drivers/operators, and other dispatching parameters.

### SUMMARY OF THE INVENTION

The present invention addresses the above problems by providing methods and systems for forecasting future ridership and demand for bus and other transportation services based upon actual measured or counted use. Briefly, automatic passenger counters combined with vehicle locators are used to provide count data for use of a route with a number of stops. At the stops, passengers are counted as they board (oncounts) and debark/leave (offcounts) at each stop. The route may be divided into a number of origin-destination pairs (e.g., a stop where passengers embark is paired with a stop where passengers debark). The count data is gathered over a period of days, weeks, and months, and this historical data or passenger count for the route is then attributed to the route as demand or passenger use of the route, and, more typically, the demand is associated with each OD pair at the specific time of the entry/exit event. The historical OD pair-demand data may then be processed by forecasting and planning software to better forecast future demand. For example, a ridership forecasting tool may use the OD pair-demand data to forecast future demand for buses on the route, and labor and dispatching tools may use this demand (or demand that is further granularized to be associated with each OD pair per time period such as every 15 minutes) to optimize bus routes/schedules and labor assignments that best fit the guest demand profile.

More particularly, a method is provided for forecasting demand for transportation services. The method may include running a count-to-demand translation module with a processor on a computer system and, at or with the computer system, receiving a set of count data for at least one vehicle operating to transport passengers along a route with multiple stops. The count data (e.g., APC count data) includes a count of passengers getting on each vehicle at each of the stops and a count of passengers getting off each vehicle at each of the stops (e.g., oncounts and offcounts for each stop). The method also includes operating the translation module to determine a demand for pairs of the stops on the route based on the on and the off counts for the at least one vehicle. In some cases, each of the pairs comprises an origin stop (e.g., a stop where one or more passengers board) and a destination stop (e.g., a stop where one or more passengers debark the vehicle), and most routes will include 2, 3, 4, or more OD pairs (with 2 or more origins and at least one destination). The set of count data includes a geographical location (e.g., a GPS-based location) associated with the on and the off counts for each of the stops, and the count data also includes a time associated with measuring of the on and the off counts with an APC or other device mounted on the vehicle.

The demand found by the translation module is attributed to predefined time periods (e.g., every 15 minutes or the like or each OD pair or the like). In the method, the demand of at least some of the OD pairs of the stops is proportional to the offcounts at the destination one of the stops in the pairs relative to the offcounts in the other destination stops. The method may also include storing the demand determined for each of the pairs in memory of the computer system, providing the demand to a forecasting module run by the processor of the computer system, and operating the forecasting module to generate a forecast of future demand for the route based on the determined demand. In theme park implementations, due to the complexities of the theme park route, there are a lot of special cases that complicate the algorithm.

### BRIEF DESCRIPTION OF THE DRAWINGS

FIG. 1 is a functional block diagram of a transportation system with a fleet of vehicles (e.g., buses or the like) adapted to transmit location and passenger count data (e.g., APC data) to a ridership prediction and dispatching system for use in associated measured demand with origin-destination (OD) pairs for a number of vehicle routes;

FIG. 2 illustrates schematically a geographical area serviced by a transportation system (such as the system of FIG. 1) illustrating OD pairs for an exemplary simplified route;

FIG. 3 illustrates exemplary input data or automatic passenger count (APC) data received from vehicles and stored in memory of a ridership prediction and dispatching system;

FIG. 4 illustrates exemplary output data of a ridership prediction and dispatching system such as from a passenger count to OD pair translation module or similar software tool used to determine demand and allocate it to OD pairs per time period;

FIG. 5 is a functional block diagram of a guest/rider transportation planning and deployment system of an embodiment showing use of APC data and other information from a bus fleet to produce OD-demand data that is processed by a guest demand forecast mechanism to produce demand profiles for a route (and for OD pairs of that route) for each time interval of a day; and

FIG. 6 illustrates a process for associating ridership information (e.g., APC data) with OD pairs such as may be implemented by operation of the systems of FIGS. 1 and 5; and

FIG. 7 illustrates a process for further processing ridership or APC data from a fleet of vehicles to provide accurate OD pair-demand data including determining when passengers or riders arrived at pick up locations or origins, to the nearest 15-minute time interval.

### DETAILED DESCRIPTION OF THE PREFERRED EMBODIMENTS

Briefly, embodiments of the present invention are directed to methods and systems for better predicting or forecasting demand for vehicles such as buses within a transportation system, e.g., a resort complex where guests are transported from lodging to entertainment facilities/locations, a regional transportation district providing bussing to its citizens, a van service from airports, and so on. More specifically, the following descriptions highlights the use of counts of passengers boarding and leaving a vehicle, such as a bus, at various stops to determine in a more accurate manner the historical demand for transportation on a set of bus routes.

The demand is determined in part by assigning riders or passengers to particular routes in a more granular manner such as by dividing a route into a set of origin-destination (OD) pairs and then assigning the measure rider counts to particular OD pairs. Further, the demand is determined over time such that the demand data includes rider counts for OD pairs for particular time intervals on a daily basis (e.g., demand may be a number of passengers that used a bus on a particular route to travel from a particular origin or stop to another stop or destination (an identified OD pair) on a particular day in the interval of 8 AM to 8:30 AM or some other time period). The OD pair demand data may be fed to one or more planning tools such as guest or rider forecast tool that may combine this data with other operating parameters to generate significantly improved demand profiles for a bus fleet and its operators/drivers. Further, the demand profiles may then be used to create labor assignments/schedules and routing information (e.g., number of buses serving a route or even OD pair of a route, driver schedules, scheduling of bus dispatches to locations, and the like).

The inventors recognize that service standards, such as short waiting periods for a next bus, can better be maintained or achieved when guest or passenger demand is more accurately estimated. However, it is also understood that determining how to route buses, how many buses to provide on each route, and how often to dispatch buses on each route is a very difficult task, especially when performed without accurate ridership data or generalized passenger counts. For example, a transportation system may be made up of ten to hundred buses or more with one exemplary transportation system studied by the inventors including nearly 300 buses that carry a ridership of approximately 150,000 daily guest or passenger trips. In the resort/entertainment complex setting, the operating hours and resort population changes every day, which requires customized dispatch schedules based on these changing operating conditions. Similarly, public transportation systems see variations that vary with each day of the week and vary during the day. To address these challenges, the process described herein outfits each bus with automatic passenger/people counters (APCs) to determine when passengers board and leave a bus and automated vehicle locators (AVLs) to determine via global satellite positioning (GPS) the location of the bus at particular times. The APC and AVL information (sometimes shortened to APC data in the description) provides records of actual ridership for each bus of a fleet, and the measured ridership data is utilized to predict future ridership.

Before providing specific examples, it may be useful to provide a high level overview of the use of actual ridership data to predict future demands for a vehicle fleet. An exemplary ridership prediction and dispatching system may include on-board APCs and GPS location devices on each bus to provide APC data, and, significantly, tie the measured bus ridership to GPS-provided locations at a specific time. A conversion or translation algorithm may be used to convert raw ridership to demand by OD pair by a time period (e.g., demand for an OD pair for N minutes such as 15 minute periods, 30 minute periods, and the like). Typically, routes may have multiple origins and destinations (e.g., multiple OD pairs within a single bus or transportation route as passengers board at multiple stops and/or debark at more than one stop/location), and multiple OD pairs per route makes conversion of raw data to OD pair demand data difficult and complicated. Most routes have either multiple origins or multiple destinations, and, occasionally, destinations are served in the succeeding route.

In some embodiments, two conversions are performed for the raw data conversion or translation. First, a determination is made of how many guests/passengers alighted at each stop for each specific destination. This determination is followed by determining the appropriate time bucket or period for the raw ridership data (e.g., corresponding 15-minute time bucket), such as by determining the last time the OD pair associated with the data was serviced by a bus. The time bucket determination may also involve projecting the guest/passenger arrival rate since the last service time. This determination considers the number of passengers that got on at that particular stop and the percentage of passengers that depart at each destination. Hence, the ridership prediction method taught captures actual ridership and attributes this raw ridership in an accurate manner to OD pairs of a number of routes to provide demand per OD pair for each time period of a day (e.g., ridership/passenger count for each 15 minute period of a day for a bus traveling between an OD pair on a particular route).

The method may further include providing the OD pair demand data as input to a sophisticated forecasting technique to generate a guest demand forecast for one or more upcoming days. The forecasting module/software may process a single day's OD pair data but more typically will include data from at least a few days and more typically months of historical OD pair demand data to improve the accuracy of the forecasts of passenger demand for transportation services. No other transit system tracks guest/passenger counts to individual OD pairs and specific time periods. It is expected that such ridership data may prove to be a major asset to municipalities, van/cab services, and resort (or other entertainment complex) operators because they could track demand and customize their schedules (bus dispatches, driver work assignments, and the like) to match the demand.

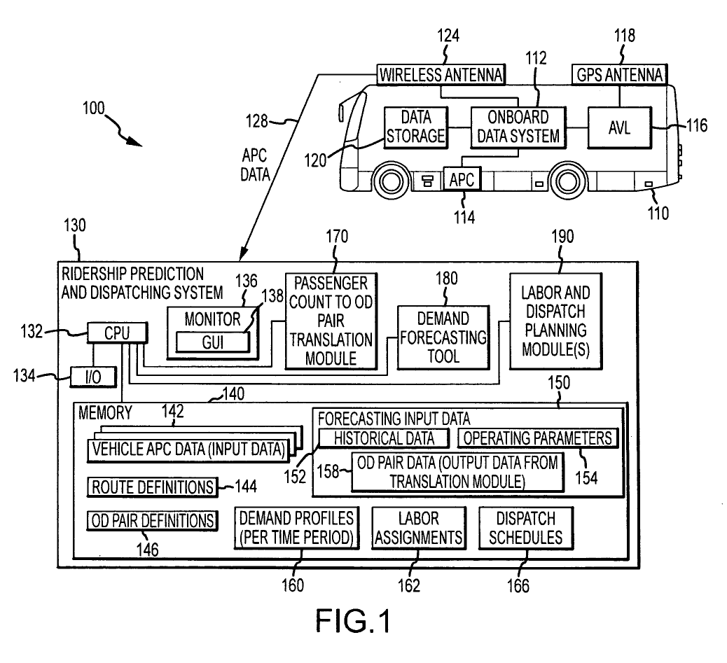

FIG. 1 illustrates a functional block diagram of a transportation system 100 of an embodiment of the invention. The transportation system 100 includes a fleet of vehicles (with “vehicle” being used interchangeably with “bus”) 110 and a ridership prediction and dispatching system 130 for processing measured or “actual” passenger use (ridership) of the buses 110 and to process this data to better determine demand for the buses 110. The demand is then used for forecasting future demand and then planning labor assignments and dispatching (e.g., routes, buses, frequency of runs, and so on) based on this more accurately forecasted demand.

To this end, each bus 110 may be outfitted or retrofitted to include an onboard data system or mobile data terminal 112 (e.g., a processor or computer-based system for managing communications, running software, managing hardware, and storing and retrieving data from memory such as storage 120). An automatic counter or APC 114 is provided on bus 110 to count passenger or people using the bus 110 and, more typically, for determining movement of people or counts in both directions (e.g., counting embarking or loading passengers as well as counting debarking or offloading passengers from the bus 110). A variety of APCs 114 may be used such as infrared beam-type APCs (e.g., passive IR counters, target reflective IR counters, active IR counters, passive optical, or the like), radio beam APCs, pressure pad-based APCs, magnetic APCs, induction loop APCs, and the like located on the path(s) of the passengers (e.g., near the door(s) of the bus 110). The signals from the APC 114 are processed by the data system 112 to log the counts of loading and unloading passengers (e.g., “OnCounts” and “OffCounts” in some embodiments). The Onboard data system 112 may create or manage a set of APC data or APC data records based on these counts. In some cases, the counts are logged for each stop (e.g., for each origin or destination for the bus 110 on a route) by the data system 112 and stored in data storage 120 or transmitted after each stop via the wireless communication antenna 124 (or devices such as a built-in GSM or mobile phone modem or the like) as APC data 128 (with data sometimes being formatted or readily converted to spreadsheet or table format for read manipulation and data analysis by the ridership prediction system 130 including showing trends and matching demand to OD pairs). For example, at each stop, the APC 114 may act to generate a set of OnCounts and a set of OffCounts indicating, respectively, the number of passengers embarking and debarking from the bus 110 and these actual/real time counts are stored by the data system 112 in storage 120 with reference to the time, date, and other information.

Specifically, the other information tracked may include location information (e.g., which allows matching to the stop) and optionally a route ID and a vehicle ID. To provide location information, the bus 110 may include a location device 116 such as, but not limited to, an automatic vehicle location (AVL) component that uses a satellite-based global positioning system (GPS) antenna 118 to obtain the location of the bus 110 when the counts are made by the APC 114. The location information may be stored as raw location data in data storage 120 for transfer in APC data 128 or it may be used by the data system 112 to lookup a corresponding stop ID or location, with the stop ID/location being associated with the counts from the APC 114 in memory 120. Additionally, the system 130 knows or is aware of the route network and may store the route network information in memory 140. In some embodiments, commercially distributed computer aided dispatch/automatic vehicle location (CAD/AVL) products are used as part of the system 100 such as to provide the vehicle location components, communication components (such as antenna 124 and transceivers (e.g., part of I/O 134) at system 130), and a portion of the prediction and dispatching system 130 (such as dispatching consoles (e.g., monitors 136 and/or GUIs 138 or other devices not shown) for monitoring and managing dispatching of vehicles 110). Such devices may be used to provide functions such as engine monitoring, vehicle tracking, and destination marquee/signage control.

The collected APC data 128 is transmitted to the ridership prediction and dispatching system 130 such as after each stop or periodically (such every few hours or other fixed or variable time period). In other embodiments, though, the APC data 128 is stored in memory 120 and then downloaded or transferred to the system 130 in a wired manner or via transferred storage media (e.g., memory sticks, disks, or the like). The system 130 includes a CPU 132 for managing operation of I/O devices 134 such as keyboard, a touchpad/screen, a mouse, and wireless communication devices for receiving APC data 128. The I/O devices 134 may also include one or more printers for printing hard copies of OD pair data 158, demand profiles 160, labor assignments 162, dispatch schedules 166, and/or other output generated by the system 130. A monitor 136 is included to display information being processed by system 130, to display a GUI 138 that may facilitate data display and/or input by an operator (e.g., to adjust time period lengths used by OD pair translation module 170 or to adjust other processing variables or request particular outputs/reports), and/or to display outputs of the system such as OD pair data 158 and dispatch schedules/information 166.

The system 130 further includes memory 140 for storing data in digital form such as vehicle APC data (input data) 142 received from the buses 110. Other data used in processing the actual input data 142 may be stored in memory 140 including route definitions 144 as well as OD pair definitions 146. Bus routes are generally defined to include a plurality of stops or pickup/dropoff locations and end at a particular location or destination. However, each route may have numerous origin-destination (OD) pairs as passengers embark the bus at differing stops (differing origins) and, in some case, get off prior to the final destination creating another destination (e.g., a same origin stop may have more than one destination for the same route to create more than one OD pair for the same origin stop).

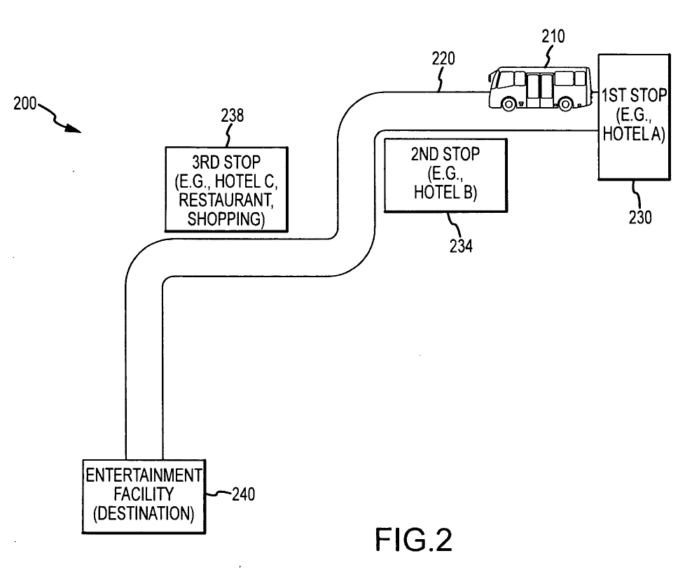

FIG. 2 illustrates a relatively simple transportation network or region 200 serviced by a transportation system with its buses 210. The route of the bus 210 may be the road or street 220. The route 220 may travel from a first stop (or hotel) 230 to an entertainment facility or other end destination 240. Also, the route 220 includes two intermediate stops 234, 238, and passengers may load at all three stops (origins) 230, 234, 238. The passengers may debark from the bus 210 at the entertainment facility 240 but also at intermediate stops 234, 238, and this creates numerous OD pairs just for this simple route (e.g., 230-234, 230-238, 230-240, 234-238, 234-240, and 238-240) and just when considering this travel direction, with another set of OD pairs being defined for travel from entertainment facility 240 back to the first stop/hotel 230. To better understand demand and, then, forecast demand and plan labor assignments and dispatching, it is useful to define routes and then for each route define OD pairs (as shown in memory 140 at 144, 146), and next to attribute the actual passenger counts/demand to these OD pairs. For example, such knowledge of demand may indicate that one or more buses 210 should be run on route 220 or one or more buses should be provided for subparts of the route such as to service particular OD pairs determined or forecasted to have heavy demand.

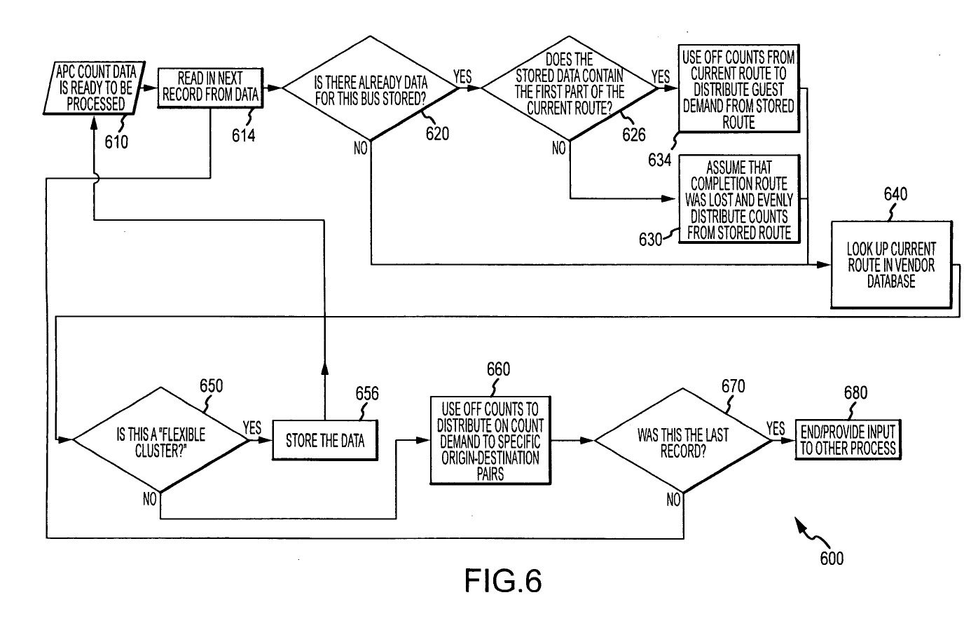

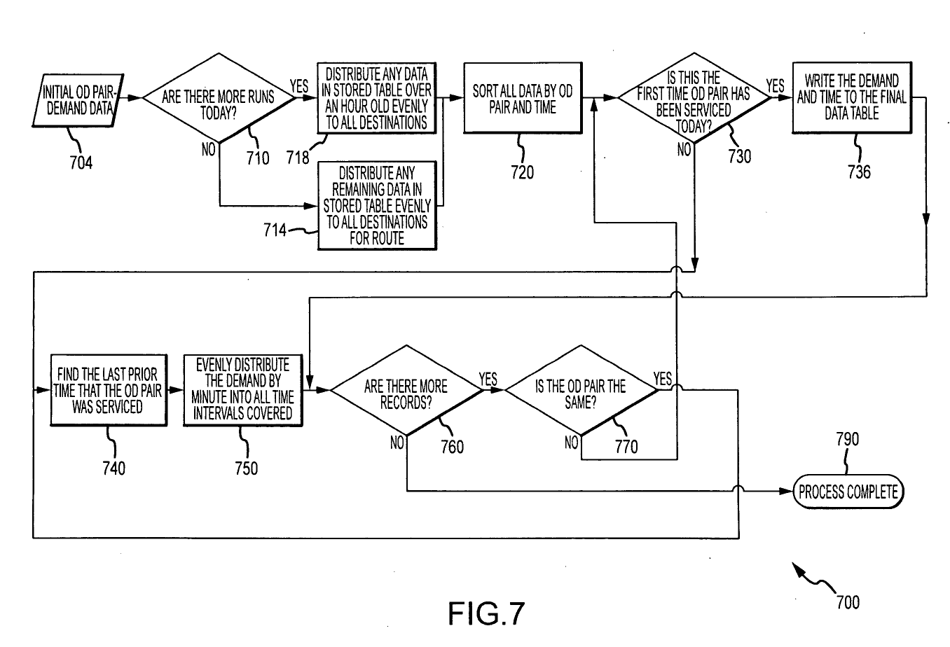

Referring again to FIG. 1, the ridership prediction and dispatching system 130 includes a passenger count-to-OD pair translation module 170 (e.g., software routine or the like provided in computer readable medium and run by CPU 132 to perform the described functions such as shown in FIGS. 6 and 7). Briefly, the translation module 170 processes the vehicle APC data 142 and generates OD pair data 158 stored in memory 140 and/or output to I/O devices 134 and/or monitor 136. The OD pair data 158 generally attributes the counts from the APC 114 to particular OD pairs of a route such as passenger counts or demand per predefined period of time (e.g., 15 minute intervals for each operating day for a bus 110 or vehicles on a route). The OD pair data 158 may be considered a portion of a set of forecasting input data 150, which may further include historical data 152 (such as attendance at an entertainment facility, lodgers or population of a resort or hotel complex, and so on) and operating parameters/information 154 (such as operating hours, special events, day of week for which forecast is desired, past or predicted weather, and so on). Any information referenced in operating parameters/information 154 has a historical counterpart in historical data 152.

The demand forecasting tool 180 may be run by the CPU 132 using the forecasting input data 150 including the OD pair data 158 to generate a set of demand profiles 160 (e.g., expected demand or passenger counts for each OD pair and/or bus route for future days/weeks/months per time period of the operating time). These demand profiles 160 may be stored in memory 140 and/or output as reports or displays (or as input to other processes) via CPU 132 such as using I/O 134 or GUI 138. For example, the system 130 includes a labor and dispatch planning module(s) 190, and this module 190 may process the demand profiles 160 with or without other data and generate labor assignments 162 assigning drivers and others to support a fleet of buses 110 and dispatch schedules 166 indicating for each route how many buses will service the route, when such buses are to be dispatched, and so on. The module 190 may also function to decide how to group OD pairs and select the routes to dispatch.

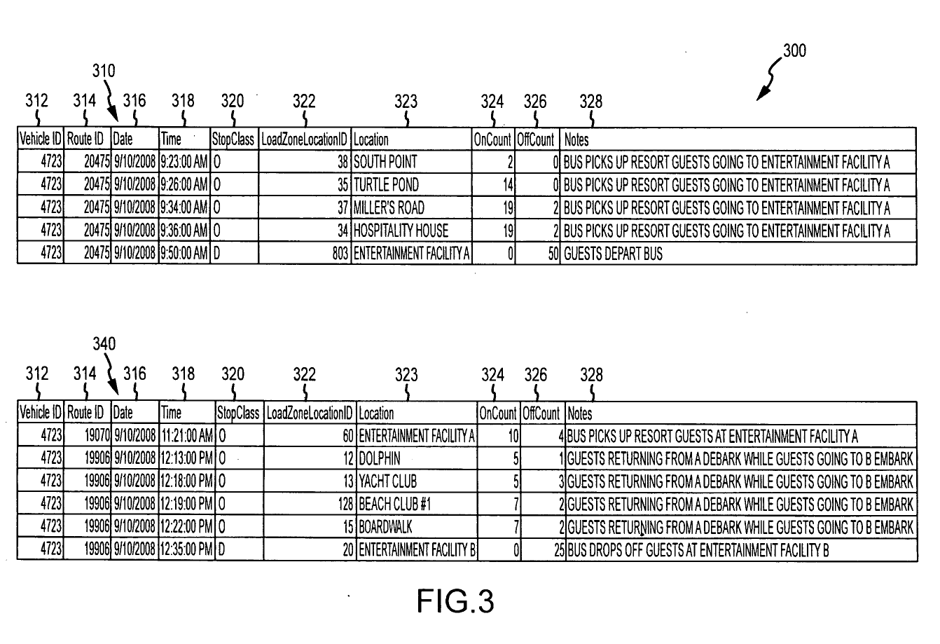

FIG. 3 illustrates an example 300 of vehicle APC data 142 created using an APC 114 of a bus 110 and/or providing further processing/data input by onboard data system 112 and/or components of system 130. As shown, the APC data set 310 (shown in table or spreadsheet form) is provided for one route while APC data set 340 is provided for another route. In each APC data set 310, 340, the data includes a vehicle ID 312, a route ID 314, a date 316 and time 318 that the data was collected/measured, and a stop class 320 (e.g., is the stop generally an origin stop for this route or a destination stop). Further, the data 310, 340 includes a location of the stop 323 (with a load zone location ID 322 associated with the location name/description 323) such as may be determined based on the GPS location data from AVL 116 and the route that the bus is servicing or the like (e.g., via a look up of the GPS location data to a stop in the vicinity of the GPS location of the vehicle at the stop). In some cases, the system only sends counts if it can match them to a stop on the route that the bus is operating at the time.

For each location/stop, the data 310, 340 also include APC-provided counts 324, 325 of people getting on and getting off the bus (e.g., the APC is direction sensitive). As shown, some stops are only origin stops or destination stops with all counts being in one direction (on or off) while some stops have people that embark and that debark (on and off at single stop). As a result, the overall oncount will often not equal the offcount at the final destination stop of the route. Further, in data 340, there are situations where there are riders already on a bus when it starts a route, which can result in offcounts at the first origin stop. In some embodiments, the assigning of counts to OD pairs may be relatively simple with all on counts of an origin stop being assigned to the OD pair (e.g., with one main destination such as the entertainment facility A in FIG. 3). However, in other embodiments as explained with reference to FIGS. 6 and 7, more detailed passenger/demand attribution is performed to account for passengers departing/debarking at more than one stop, passengers loading and unloading at single stops, and other parameters (such as how long did the passengers wait prior to being picked up such as to account for a bus having to pass by a stop because it was full and so on).

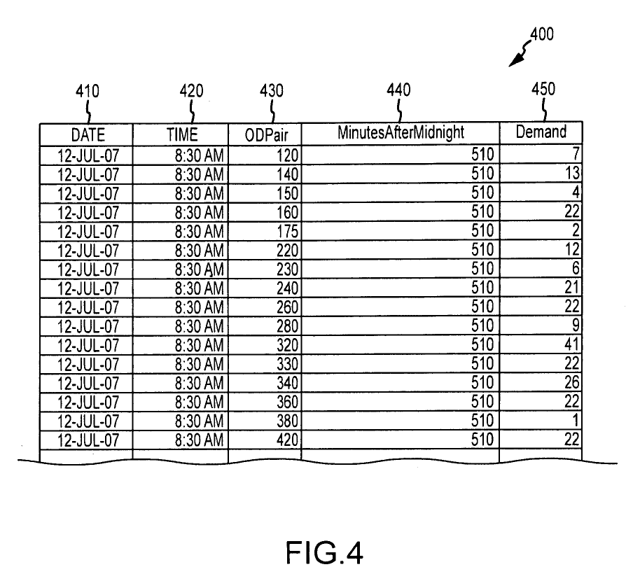

The APC data 300 (or 142 in FIG. 1) is processed by the passenger count-to-OD pair translation module 170 to produce a set of OD pair data 158. An example 400 of such OD pair data produced by module 170 is shown in FIG. 4. As shown, the OD pair data 158 includes a date 410 and a time period 420, 440 (e.g., starting time of an “x” minute interval such as a 15-minute interval, a 30-minute interval, or the like or period start time relative to a time of day like midnight as shown in FIG. 4) corresponding to the day and time the APC data was collected for one or more buses on a route (e.g., more than one bus may service a route and its OD pairs and such count data may be combined to produce demand for the OD pairs). The data 400 also includes an identifier of the OD pair 430 for which the demand corresponds, and this identifier (an integer being shown as a non-limiting example of an OD pair identifier) may be used to look up a description of the OD pair (e.g., its origin and destination locations). Significantly, the data 400 includes a demand value 450 associated with each OD pair 430 for each time period 420. The demand in this case is a count of passengers using the service during that time period, and demand data would be provided for each day the transportation service was provided (or APC data was gathered) and for the operating hours for the route/service. The granularity of information to the OD pair level provides surprising information or at least information that was unavailable under older systems that only provided dispatch information, with any demand information having to be manually collected. For example, it is clear that the demand is not equally divided among the OD pairs, with some OD pairs having a much higher demand than others, and the OD pair demand data may be used to enhance service (such as by providing a “route” or bus that begins service in the route at points of higher demand such as a bus that starts service with the 320 OD pair or the like).

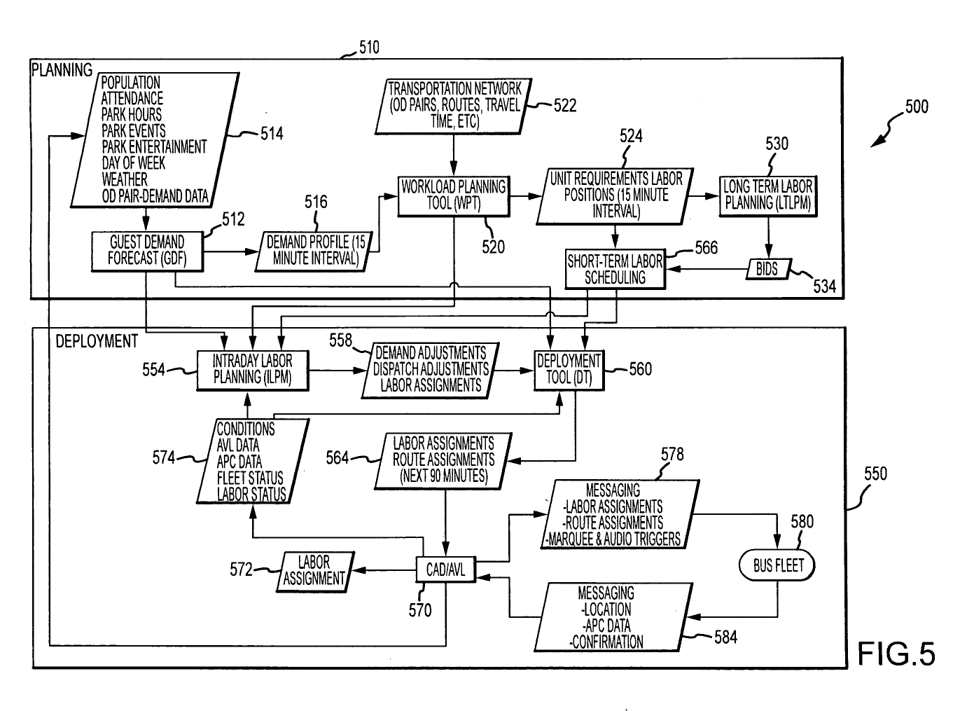

FIG. 5 illustrates a planning and deployment system 500 that may be implemented and utilized according to embodiments of the invention (such as by operation of the system of FIG. 1 with the software modules/algorithms/tools and data sets of system 500 having the same/similar or differing names but providing similar functionality). The system 500 is shown to include a planning subsystem 510 and a deployment subsystem 550. The planning subsystem 510 includes a guest demand forecast module 512 that processes input data 514 such as historical guest and passenger demand data and other property information to produce a forecast of future guest/passenger demand 516 (e.g., demand profiles for transportation services per time period). For example, the historical data 514 may include OD pair-demand data as shown in FIGS. 1 and 4 and may also include other property management data such as historical attendance of a facility/event, population of serviced hotels or local buildings, hours of operation, planned events/activities (such as concert, a sports game; a parade, and so on), day(s) for which forecast is required (as demand likely varies based on day of week, time of year, and so on), and historical/forecast weather during time period.

The planning subsystem 510 further includes a workload planning tool that uses the demand profile 516 from the guest demand forecaster 512 along with transportation network data 522 (e.g., OD pair definitions, route definitions, travel times for buses on the route/OD pair, and so on) to determine service level for each OD pair, which may be stated as numbers of buses and/or drivers as shown at 524 with unit requirements/labor positions for each time interval (e.g., for time periods of demand profiles 516). The planning tool 520 may also function to optimally route buses and then to use these routing decisions to determine the bus workload for each operational day. A scheduling module 566 may be used to process unit requirement and labor position data 524 to provide scheduling information to processing tools of the deployment subsystem 550 (e.g., to pass-thru data 524 and/or to further refine the data to suit a particular scheduling, planning, and/or deployment tool). The data 524 from the workload planning tool 520 may further be fed to a longterm labor planning tool 530 that generates long-term bids or bidlines 534 that establish longer term worker and/or driver availability based on satisfying workload determinations 524 by planning tool 520 subject to other parameters (such as union rules, worker satisfaction metrics, and so on). Typically, bids are used to define a worker's availability or shifts over the next fixed periods of months. The bid data 534 may be used to limit the scheduling performed by module 566 and, hence, input provided to deployment subsystem 550.

Data generated from the planning subsystem 510 may be transferred to the deployment subsystem 550 for use in generating labor assignments and specific bus dispatching schedules based, at least in part, on the OD pair-demand data 514. For example, an intraday labor planning module 554 may receive input from the guest demand forecaster 512, the workload planning tool 520, and the scheduling tool 566. The intraday labor planning module 554 outputs labor assignments and adjustments to the demand and dispatches 558. The planning module 554 may look at all labor decisions for a time period (e.g., for the time period after operation of the deployment tool 560 to the end of the day) such as driver breaks, end of shifts, and other worker requests. The planning module 554 may operate to limit operation of the deployment tool 560 such as to prevent the tool 560 from sacrificing the needs of bus drivers to improve optimality of the bus routes and servicing passengers.

The deployment tool 560 takes output from the intraday labor planning module 554 as well as the demand forecaster 512 and the scheduling tool 566. The deployment tool 560 may be adapted to process this input to optimize an upcoming time period of operation of the managed transportation system (or bus fleet). For example, the tool 560 may process the input data and try to optimize the next 90 minutes of dispatch and labor assignments (with these optimized assignments output at 564). The optimized labor and route assignments 564 are fed to another software module labeled in FIG. 5 as the CAD/AVL module 570 (e.g., computer aided dispatch/automatic vehicle location). The CAD/AVL module may provide messaging 578 of labor assignments, route assignments, and, in some cases, output labor assignment reports 572 (for reporting to drivers and other workers in other messaging methods such as hard copies posted in a work area and the like). The messaging 578 is delivered (typically wirelessly as shown in FIG. 1) to the buses or vehicles of a fleet 580. The bus fleet 580 delivers messaging 584 back to the CAD/AVL 570 including APC data and location data, and this APC data is transferred directly or as shown from the CAD/AVL 570 to the demand forecaster 512 for use as input data 514 for performing demand forecasts including demand profiles 516. The CAD/AVL module 570 may also output data for use in labor and deployment by tools 554, 560 such as conditions, AVL data, APC data, fleet status, and labor/driver status.

With the above description understood, it may be useful to provide a more detailed discussion of translating APC data or counts into OD demand. In the following discussion (or some embodiments), the APCs are automatic people counters such as photocell-type devices that count passengers or riders as they embark and disembark from the bus (e.g., a device able to determine direction of flow/movement). The term “demand” may be thought of as a measure of how many passengers will be requiring transportation in forecasting terms. An OD pair is an origin-destination pair and demand is typically attributed or assigned to each pair (e.g., demand from a single origin to a single destination), with this typically being the lowest level of demand forecasted. A route is a grouping of origins, and/or destinations that services the demand. For example, a route traveling from a resort to an entertainment facility or a natural attraction such as a beach or ski hill may cover three OD pairs (e.g., three stops within the resort complex such as three hotels/lodging buildings or three cross streets or the like). A “flexible route” may be a route with OD pair destinations that are not actually covered by the stops physically assigned to the route, and such an arrangement may happen when the bus is dropping off guests from one location (an origin) while simultaneously picking up guests/passengers for another destination (such that the stop is a destination for some passengers and an origin for others, which affects demand attribution in some embodiments).

Generally, demand information comes from APC counters on the buses in the form of oncounts and offcounts as well as including location of the demand (e.g., the GPS location of the bus) and route ID. The translating of the APC data includes determining whether complete route information has been received/processed or if the route is a flexible route. If the route is a flexible route, the attribution or translating process may wait until the counts from the next route are received to determine where guests exited from the bus. The translating process continues with using the oncounts for demand at each origin. If there are multiple destinations for the route, then the demand has to be distributed (in some embodiments) to the assigned OD pairs. To determine how many guests to assign to each OD pair, the translating in one embodiment includes looking at the departures at each of the destinations as a percentage of total departures. These percentages are then applied to the demand at each origin to calculate how much of the demand will be assigned to each destination from that origin. It is assumed that passengers have the same destination distribution regardless of origin.

FIG. 6 illustrates a count or APC data translation method 600 that may be utilized to assign raw passenger count data (oncounts and offcounts at each stop) to particular OD pairs. Generally, the method 600 may be implemented by a system such as system 100 that uses a translation module 170 to process vehicle APC data 142 retrieved from memory 140 or as it is periodically received 128 from operating vehicles 110 (e.g., module 170 may be provided in computer readable medium or memory and be configured to cause the computer to perform the steps or functions shown in FIG. 6). At step 610, the method 600 includes determining whether APC count data is ready to be processed (or receiving/retrieving a batch of such data such as the data for a particular day or the like). At step 614, the next record of data is read (e.g., one of the records from the data sets 310, 340 shown in FIG. 3). At step 620, the method 600 includes determining if there already is data stored for this bus in memory. If not, the method 600 continues at 640 with looking up the current route in a database (e.g., with the ID of the route and/or the location information provided in the APC data). Then, at 650, it is determined if this is a flexible route, and if so, the method 600 calls for storing the data 656 (e.g., the route ID and APC data in a record such as shown in FIG. 3) and then continuing at 610 with the next record 310, 340 of passengers getting on and/or off the bus.

If at 620 it is determined that data had previously been stored for this bus, the method 600 continues at 626 with a determination of whether the stored data contains the first part of the current route. To determine if the stored data is part of the current route, the system looks at which destinations were in the stored route's OD pairs but were not covered by the actual list of stops for the route. The system then looks to see if those uncovered destinations are in the current route's list of stops. If yes, at 634, the method 600 includes using the offcounts from the current route to distribute guest demand from the stored route. The method 600 continues with performing steps 640 and 650. When the route is determined to not a flexible route at 650, the method 600 continues with step 660 with using the offcounts to distribute oncount demand to specific OD pairs. For example, a route may have two stops where passengers debark or leave a bus (or where offcounts occur), and, hence, these two stops would be destinations. The origin stops to be paired with these two destination stops would be the stops where oncounts occurred before or upstream of these two destination stops. The oncounts are proportionally assigned to each OD pair (e.g., each upstream origin stop is paired with the downstream destination stops) to distribute the measured demand.

For example, the route may have 50 oncounts for the origin stops upstream of the 2 destination stops and 10 offcounts at the first destination and 40 offcounts at the second destination. In this example, at step 660, the oncounts would be proportionally assigned to each OD pair such that 20 percent were assigned to the first destination and 80 percent to the second destination (e.g., if 10 people got on a bus at a first stop of a route, the OD pair of this first stop and the first destination would have a demand of 2 passengers/riders whereas the OD pair of this first stop and the second destination would have a demand of 8 passengers/riders). The attribution 600 may ignore the oncounts at the first destination in this proportional calculation as it would be assumed that these oncounts were only upstream of the second destination and have to be assigned to the demand of the OD pair of the first destination stop (which is an origin when paired with the second destination) with all the oncounts being considered demand for this OD pair. As will be appreciated, the proportional assigning of oncounts based on the location of offcounts on the route is one useful method of assigning demand, but the invention may be implemented using other attribution techniques (and with some modifications as discussed with reference to discounting the oncounts at the immediately upstream stop for a final destination as these passengers are necessarily traveling to the next and last stop). Any oncounts at a location not considered an origin or offcounts not considered a destination for the routes covered will be disposed.

If at 626, it was determined that the stored data did not include the first part of the current route, the method 600 would include evenly distributing the counts to the OD pairs from the stored route (rather than performing proportional distribution as discussed above based on offcounts). At 670, it is determined whether there are additional records to process at this time. If so, the method 600 continues at 614, and if not, the method 600 may end at 680 or the OD pair-demand data may be stored in memory and/or output to other processes (as discussed with reference to FIGS. 1 and 5 for example) or used to generate a report/display. The stored OD pair-demand data generated via process 600 may take the form 400 shown in FIG. 4.

Two specific examples for FIG. 6 follow. For the first example, assume that a route servicing five origins and three destinations is completed. The counts recorded are as follows: O1, 15 on; O2, 18 on; O3, 21 on; O4, 0 on; O5, 3 on; D1, 12 off, D2, 24 off; D3, 0 off. In this example, one third of the passengers exited at destination 1 and two-thirds exited at destination 2. It will be assumed that all passengers at each origin will follow this distribution, such that the OD Pair demand results as follows: O1-D1, 5; O1-D2, 10; O1-D3, 0; O2-D1, 6; O2-D2, 12; O3-D1, 7; O3-D2, 14; O4-D1, 0; O5-D1, 1; O5-D2, 2. All OD Pairs not listed have a count of zero and are left out for simplicity's sake. For the second example, assume that the route is servicing three hotels, A, B, and C, to a destination. When the system checks the stored data table, it finds a route for this same bus that has these three hotels as destinations. For this stored route, a count of 48 passengers was recorded at the origin Z. On the new route, counts of 24, 24, and 12 are recorded disembarking the bus at resorts A, B, and C, respectively. The exit counts are used to figure out a destination distribution of 40% at Resort A, 40% at Resort B, and 20% at Resort C. Multiplying the percentages by the on counts at the original origin leads to assigning 18 passengers to the Z-A OD pair, 18 to the Z-B OD Pair, and 9 to the Z-C OD pair. The on counts at each of these resorts will be recorded and will run through the process separately.

In many cases, it is desirable to further process the OD pair-demand data to determine and/or to reflect when guests/passengers really arrived at various stops (origins) for pick up service. For example, the data output 704 from the method 600 may be processed as shown in process 700, which functions to translate ridership numbers into demand over time. At 710, it is determined whether there are more runs 600 to be performed today, and, if not, at 714, any remaining data is distributed in the stored OD pair-demand table evenly to all destinations for a route (as discussed with reference to the specific examples for FIG. 6 in the preceding paragraph). If more runs will occur, at 718, the method 700 includes distributing any data stored in the OD pair-demand table over an hour (or other time period) old evenly to all destinations (again, as discussed with reference to the specific examples for FIG. 6 in the preceding paragraph). At 720, the data of the table is sorted by OD pair and time. At 730, it is determined whether this is the first time the OD pair under consideration has been serviced today. If yes, the method 700 writes the demand to the output table and continues at step 760 with a determination of whether there are more records to process.

If no, the method 700 continues at step 740 with finding the last prior time that the OD pair was serviced. At 750, the demand may be evenly distributed by minute into all time intervals covered. For example, if the OD pair was serviced 10 minutes ago and 50 passengers were counted, this may result in a distribution of 5 passengers/minute and such demand may be assigned to the OD pair based on the length of time intervals utilized. At 760, the method 700 determines whether more records are available for processing and if not the method is completed at 790 (such as after storing the OD pair-demand data, e.g., as shown in FIG. 4). If yes, the method 700 continues at 740.

A more specific example for FIG. 7 follows. Assume there are four records of demand for an OD Pair: 15 passengers at 10:04, 10 passengers at 10:14, 54 passengers at 10:32, and 16 passengers at 10:40. If these counts were assigned only to the 15-minute bucket in which they were noted, demand would be recorded as follows: 10:00-10:15, 25; 10:15-10:30, 0; 10:30-10:45, 70. This would make it appear as though no passengers wanted bus service between 10:15 and 10:30 when in all likelihood the majority of the 54 passengers picked up at 10:32 arrived during that interval. To rectify this issue, the counts are spread across the time intervals covered. The 10 passengers recorded at 10:14 would equal an arrival rate of one passenger per minute between 10:04 to 10:14, the 54 passengers would translate to an arrival rate of three passengers per minute between 10:14 to 10:32, and the 16 passengers would equal an arrival rate of two passengers per minute from 10:32 to 10:40. Taking these arrival rates and aggregating how much each arrival rate contributes to each 15 minute interval results in a new set of results: 10:00-10:15, 28; 10:15-10:30, 45; 10:30-10:45, 22. The passenger count for both sets of data is 95, but the counts after the translation are a much closer approximation to true demand than using only the actual ridership.

With a general understanding of translating APC counts into demand for OD pairs, it may be useful to present an example of a technique for effectively spreading the demand over particular operating time periods for a transportation system. To this end, the following is a specific, but not limiting, example of generating OD demand from APC data over 15 minute time intervals.

1) Disaggregate route data into OD Pair APC data
a. One-way routes with single origin and single destination
   i. Set OD Pair demand equal to the OD Route APC data at time of bus departure from origin
b. One-way routes with multiple origins and single destination
   i. Disaggregate route into single OD Pairs
   ii. Use number entering at each origin as the demand for the OD Pair at time bus left each origin according to rules above

2. Translate OD Pair APC data into OD Demand
a. For each OD Pair
   i. sort by time of day
   ii. process 1^{st} APC record (with assumption that all of the demand appeared within the last 15 minutes)
      1. Let t₁ equal the arrival time of the last guests (time associated with 1^{st} APC record)
      2. Let t₀ equal the arrival time of the first guests
      3. Let w_{end} equal the end time of the previous window
      4. elapsedTime=t₁−t₀
      5. arrivalRate=count/elapsedTime
      6. Δt=w_{end}−t₀
      7. demandInLastWindow=Δt*arrivalRate
      8. Δt=t₁−w_{end}
      9. demandInCurrentWindow=Δt*arrivalRate
   iii. Loop over remaining APC records for this ID Pair
      1. Let t₂ equal the arrival time of the last guests (time associated with current APC record)
      2. Let t₁ equal the arrival time of the first guests (time associated with previous APC record)
      3. IF (t₂ and t₁ are in the same window)
      4. demandInCurrentWindow=demandInCurrentWindow+count
      5. IF (t₁ is in previous window to t₂)
      6. Let Wend equal the end time of window associated with t₁
      7. elapsedTime=t₂−t₁
      8. arrivalRate=count/elapsedTime
      9. Δt=w_{end}−t₁
      10. demandInLastWindow=demandInLastWindow+Δt*arrival Rate
      11. Δt=t₂−w_{end}
      12. demandInCurrentWindow=Δt*arrivalRate
      13. IF (t₁ is in 2 windows prior to t₂)
      14. Let w_{end} equal the end time of window associated with t₁
      15. elapsedTime=t₂−t₁
      16. arrivalRate=count/elapsedTime
      17. Δt=w_{end}−t₁
      18. demandInLastWindow2=demandInLastWindow2+Δt*arrivalRate (demandInLastWindow2 references window associated with t₁)
      19. demandInLastWindow1=Δt*15(demandInLastWindow1 references window after t₁ window and before t₂ window)
      20. Let Wend equal the start time of the window associated with t₂
      21. Δt=t₂−w_{end}
      22. demandInCurrentWindow=Δt*arrivalRate
      23. IF (t₁ is in more than 2 windows prior to t₂)
      24. t₁=t₂−15
         (reset t₁ to 15 minutes prior and go to step 5)

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method for forecasting demand for transportation services, comprising:
running a count-to-demand translation module with a processor on a computer system;
at the computer system, receiving a set of count data for at least one vehicle operating to transport passengers along a route with multiple stops, wherein the count data comprises a count of passengers getting on each vehicle at each of the stops and a count of passengers getting off each vehicle at each of the stops; and
operating the translation module to determine a demand for pairs of the stops on the route based on the on and the off counts for the at least one vehicle.

2. The method of claim 1, wherein each of the pairs comprises an origin one of the stops and a destination one of the stops and wherein the route comprises at least one of the origin-destination pairs.

3. The method of claim 1, wherein the set of count data further comprises a geographical location associated with the on and the off counts for each of the stops.

4. The method of claim 1, wherein the set of count data further comprises a time associated with measuring the on and the off counts with an automatic passenger counter mounted on the at least one vehicle.

5. The method of claim 4, wherein the demand determined by the translation module is for predefined time periods for operating the at least one vehicle on the route.

6. The method of claim 5, wherein the pairs of the stops are origin stops with positive ones of the oncounts and destination stops with positive ones of the offcounts and wherein the demand of at least some of the pairs of the stops is proportional to the offcounts at the destination at one of the stops in the pairs relative to the offcounts in the other destination stops.

7. The method of claim 1, further comprising storing the demand determined for each of the pairs in memory of the computer system, providing the demand to a forecasting module run by the processor of the computer system, and operating the forecasting module to generate a forecast of future demand for the route based on the determined demand.

8. A transportation system, comprising:
a plurality of buses;
an automatic passenger counter positioned on each of the buses;
a vehicle location mechanism positioned on each of the buses; and
a ridership prediction system in wireless communication with the buses receiving count data from the buses including a count of passengers embarking and debarking at each stop with a time and a location from the vehicle location mechanism, wherein the ridership prediction system further includes memory for storing the count data and a translation module operating to attribute the count data to origin-destination pairs of the stops on routes traveled by the buses.

9. The system of claim 8, wherein the attributing of the count data comprises determining ridership for a bus of each of the OD pairs for each of the routes.

10. The system of claim 9, wherein a demand is calculated for predefined time periods of operation of the buses based on the ridership.

11. The system of claim 10, wherein the demand calculated for each of the OD pairs is determined based on an on count for an origin stop and based on a ratio of the off count for a corresponding destination stop to a total off count for the route.

12. The system of claim 9, wherein the translation module operates to store the demand data in memory and to aggregate the demand data over a plurality of data collection periods.

13. The system of claim 12, wherein the ridership prediction system further comprises a forecasting module processing the aggregated demand data to calculate demand profiles for a future operating period for the buses.

14. The system of claim 13, wherein the ridership prediction system further comprises a planning module generating a dispatching schedule for the buses based on the demand profiles.

15. A computer-based method for predicting future ridership on a transportation route, comprising:
storing in memory a definition of a route including a plurality of stop locations for a vehicle, wherein the memory further stores predefined sets of pairs of the stop locations including origin-destination pairs;
operating the vehicle on the route including allowing passengers to embark and debark at the stop locations and further including counting embarking and debarking passengers and transmitting results of the counting as count data; and
with a translation module provided on a computing device, translating the count data transmitted from the vehicle into demand for the vehicle for each of the origin-destination pairs, wherein the origin-destination pair demand is stored in memory.

16. The method of claim 15, wherein the count data transmitted from the vehicle also includes time and location information and wherein the translating further includes assigning the origin-destination pair demand to the origin-destination pairs for a plurality of operating time periods.

17. The method of claim 16, further comprising processing the time period-based demand for the vehicle with a ridership forecasting module to generate demand profiles for the vehicle for future operating periods, whereby historical information on actual use of the vehicle is used to predict future ridership of the vehicle.

18. The method of claim 15, wherein the counting is performed by an automatic passenger counter positioned on the vehicle, wherein the transmitted count data further comprises geographic location and time information associated with output of the automatic passenger counter, and wherein the operating is performed a plurality of times over a multi-day time period.

19. The method of claim 15, wherein the count data comprises embarking counts and debarking counts for each of the stop locations.

20. The method of claim 19, wherein the demand is based on a proportionality algorithm relating the debarking count of a destination stop in the origin-destination pair to an overall debarking count for the route.
